(19) United States
(12) Patent Application Publication
(10) Pub. No.: US 2009/0122443 A1
(43) Pub. Date: May 14, 2009

(54) Disk Drive Carrier Assembly and Method

(75) Inventors: David R.B. Farquhar, Chichester (GB); David J. Orriss, Southampton (GB); Alexander S. Kay, Portsmouth (GB); Richard W. Cronk, Staines (GB)

Correspondence Address: PILLSBURY WINTHROP SHAW PITTMAN, LLP, P.O. BOX 10500, MCLEAN, VA, 22102, US

(73) Assignee: XYRATEX TECHNOLOGY LIMITED, Hampshire (GB)

(21) Appl. No.: 11/883,383

(22) PCT Filed: Mar. 16, 2006
(86) PCT No.: PCT/GB2006/000955

§ 371 Date: Aug. 1, 2007

Related U.S. Application Data
(60) Provisional application No. 60/664,171, filed on Mar. 23, 2005.

(51) Int. Cl. G11B 5/012

(52) U.S. Cl. 360/97.01

(57) ABSTRACT

A disk drive carrier assembly for carrying plural disk drives is provided. The assembly has a casing having first and second opposed ends, opposed sides, a top and a bottom. Drive cards are provided in the casing. Each drive card has a disk drive receiving portion for receiving a disk drive and provides at least one of a power and a data connection to a disk drive. A baffle arrangement splits an air stream entering the casing at a first end of the casing to flow over the disk drive receiving portion of each of the drive cards. The drive cards and the baffle arrangement are arranged so that air flows only in parallel over the disk drive receiving portion of each of the drive cards. In this way, each disk drive receiving portion receives air that has not passed over another disk drive receiving portion of the assembly.

The present invention relates to a disk drive carrier assembly for carrying plural disk drives and a method of loading a disk drive into a disk drive carrier assembly.

With the current growth in requirement for data storage that is small and portable, for example for use in portable MP3 players, digital cameras, etc., there has been recent development of small hard disk drives. For example, a number of manufacturers are producing hard disk drives of 1″ (approx. 2.5 cm) diameter, which is in contrast to the current “normal” industry standard of 3.5″ (approx. 8.75 cm) diameter hard disk drives. Naturally, the bulk of the disk drive manufacturing equipment that is already in use is configured for manufacture and testing of 3.5″ disk drives. The present invention is principally concerned with enabling use of this legacy manufacturing and testing equipment with the more modern 1″ disk drives.

According to a first aspect of the present invention, there is provided a disk drive carrier assembly for carrying plural disk drives, the assembly comprising: a casing having first and second opposed ends, opposed sides, a top and a bottom; a plurality of drive cards in the casing, each drive card having a disk drive receiving portion for receiving a disk drive and providing at least one of a power and a data connection to a said disk drive; and, a baffle arrangement for splitting an air stream entering the casing at a first end of the casing to flow over the disk drive receiving portion of each of the drive cards; the drive cards and the baffle arrangement being arranged so that air flows only in parallel over the disk drive receiving portion of each of the drive cards whereby each disk drive receiving portion receives air that has not passed over another disk drive receiving portion of the assembly.

As is known, during testing of a disk drive during the manufacturing process, the disk drive is thermally stressed by alternately passing hot and cold air over the disk drive. In this aspect, a single carrier can carry plural disk drives and yet provide for a substantially separate air flow over each disk drive. When appropriately dimensioned, the carrier can thus be used as an adaptor that enables plural relatively small disk drives (e.g. having a 1″ diameter) to be accommodated in a test slot in legacy test equipment that was constructed and arranged to allow testing of a single relatively large disk drive (e.g. having a 3.5″ diameter).

At least some of the drive cards may be arranged adjacent each other at the same height between the top and bottom of the casing, the baffle arrangement comprising at least one baffle arranged between the top and bottom of the casing for splitting a said air stream towards the sides of the casing thereby to provide a separate air flow for each of said adjacent drive cards.

At least some of the drive cards may be arranged adjacent each other at the same lateral position between the sides of the casing, the baffle arrangement comprising at least one baffle arranged between the sides of the casing for splitting a said air stream towards the top and bottom of the casing thereby to provide a separate air flow for each of said adjacent drive cards.

In a preferred embodiment, at least a first set of the drive cards are arranged adjacent each other at the same height between the top and bottom of the casing, the baffle arrangement comprising at least a first baffle arranged between the top and bottom of the casing for splitting a said air stream towards the sides of the casing thereby to provide a separate air flow for each of said adjacent drive cards of the first set, and at least a second set of the drive cards are arranged adjacent each other at the same lateral position between the sides of the casing, the baffle arrangement comprising at least a second baffle arranged between the sides of the casing for splitting a said air stream towards the top and bottom of the casing thereby to provide a separate air flow for each of said adjacent drive cards of the second set.

It will be understood that some of the drive cards of the first set may be in the second set and vice versa.

In one preferred embodiment, there are exactly four drive cards, each for receiving a single disk drive, the cards being arranged in a square or rectangular array when viewed from the first end of the casing.

The assembly preferably comprises a return air flow path to return air that has passed over the disk drive cards to the first end of the casing. This allows the air to be recirculated, thus leading to improved energy efficiency and avoiding uncontrolled venting of the air to the environment.

The assembly in one preferred embodiment comprises a plurality of slots in one or both side walls of the casing to enable disk drives to be inserted into and removed from the respective disk drive cards through the side walls of the casing. This sideways insertion of the disk drives facilitates the arrangement of baffles for dividing the air flow where such baffles are provided.

According to a second aspect of the present invention, there is provided a disk drive carrier assembly for carrying plural disk drives, the assembly comprising: a casing having first and second opposed ends, opposed sides, a top and a bottom; and, a plurality of drive cards in the casing, each drive card having a disk drive receiving portion for receiving a disk drive and providing at least one of a power and a data connection to a said disk drive; at least one of the drive cards being floatingly mounted in the casing by at least one isolator; and, said at least one drive card having at least a first detent that is constructed and arranged to engage with a corresponding detent in the casing as a disk drive is inserted into said at least one drive card, thereby locating said at least one drive card in the casing during insertion of a disk drive.

In this aspect, the floating mounting of the at least one drive card helps to reduce cross-talk between disk drives mounted in the plural drive cards as it helps to damp vibrations leaving or entering a disk drive mounted in the at least one drive card. Preferably, all of the drive cards are floatingly mounted in the casing and preferably all of the drive cards have at least one detent that is constructed and arranged to engage with a corresponding detent in the casing as a disk drive is inserted into the drive card.

Said at least one drive card preferably has a second detent that can receive a corresponding detent on a robotic arm that is used to insert a disk drive into said at least one drive card, thereby locating said at least one drive card relative to a said robotic arm.

In practice, in the preferred embodiment, a detent on the robotic arm initially engages the second detent to locate the drive card relative to the arm. Then, the robotic arm is pushed into the casing, which causes the first indent to engage the detent in the casing to locate the drive card relative to the casing. The detent on the robotic arm might be a simple projecting pin and the second detent on the drive card might be a blind recess.

The assembly preferably comprises a plurality of slots in one or both side walls of the casing to enable disk drives to be inserted into and removed from the respective disk drive cards through the side walls of the casing.

According to a third aspect of the present invention, there is provided a method of loading a disk drive into a disk drive carrier assembly that can carry plural disk drives, the assembly having a casing having first and second opposed ends, opposed sides, a top and a bottom; and, a plurality of drive cards in the casing, each drive card having a disk drive receiving portion for receiving a disk drive and providing at least one of a power and a data connection to a said disk drive; at least one of the drive cards being floatingly mounted in the casing by at least one isolator; the method comprising: engaging at least a first detent on said at least one drive card with a corresponding detent in the casing as a disk drive is inserted into said at least one drive card, thereby locating said at least one drive card in the casing during insertion of the disk drive.

Preferably, prior to said first engaging step, the method comprises engaging a detent on a robotic arm with a second detent on said at least one drive card to locate said at least one drive card relative to the robotic arm, and then carrying out the first engaging step by pushing the robotic arm in towards the interior of the casing.

Preferably, said disk drive is inserted into and removed from the disk drive card through a slot in the side wall of the casing.

Embodiments of the present invention will now be described by way of example with reference to the accompanying drawings, in which:

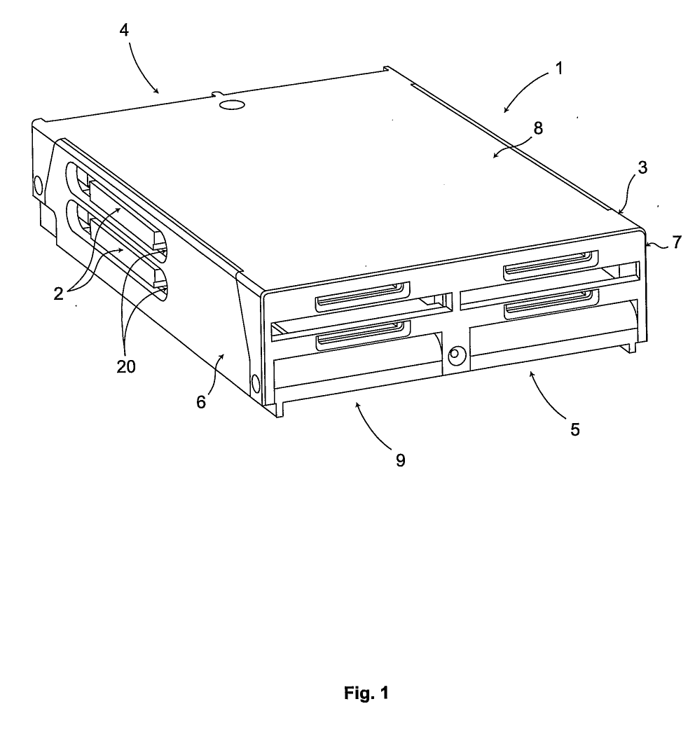

FIG. 1 is a perspective view of an example of a disk drive carrier assembly in accordance with an embodiment of the present invention;

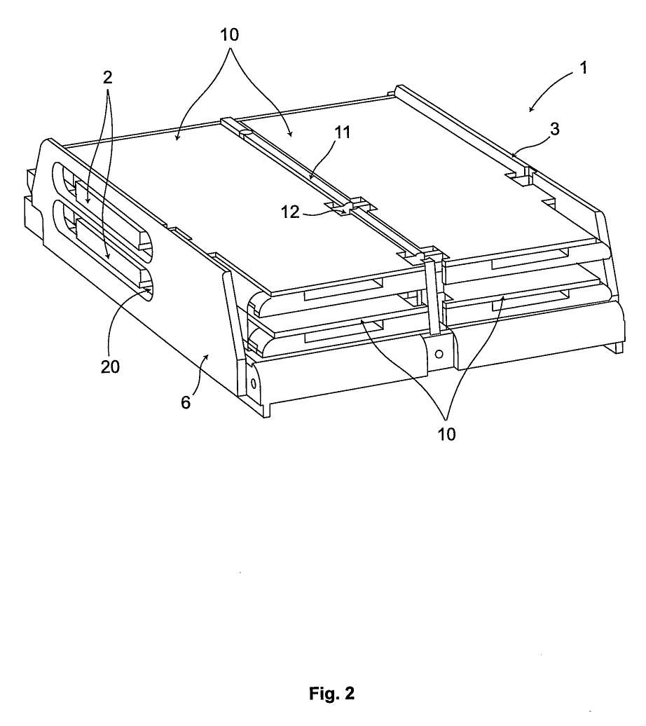

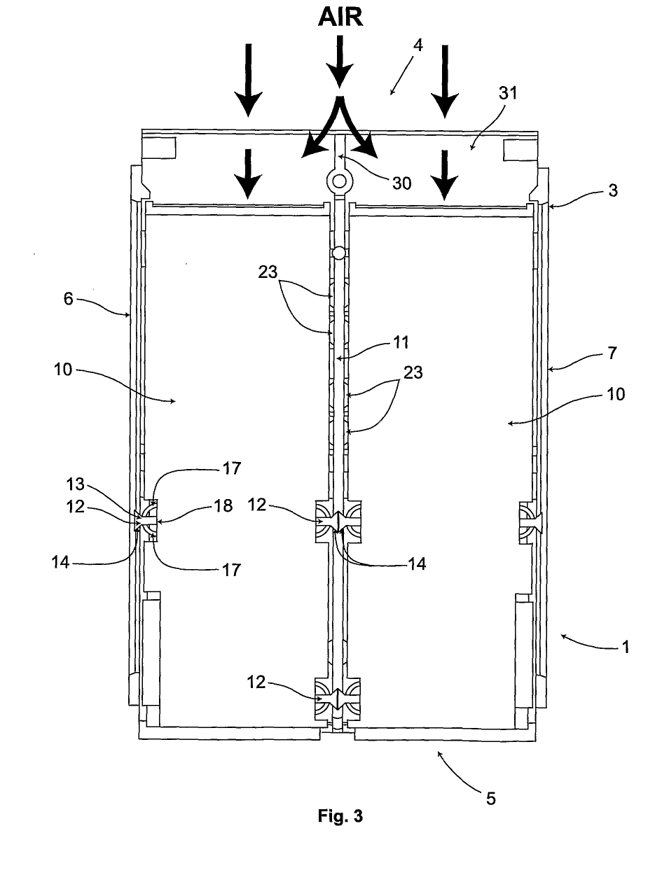

FIGS. 2 and 3 are respectively a perspective view and a plan view from above of the assembly of FIG. 1 with the top removed;

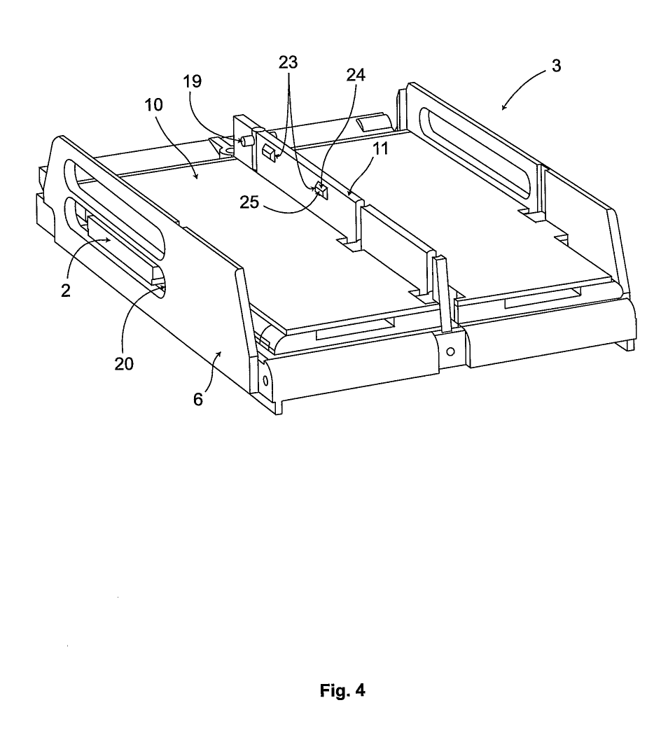

FIG. 4 is a perspective view of the assembly of FIG. 1 with the top drive cards removed;

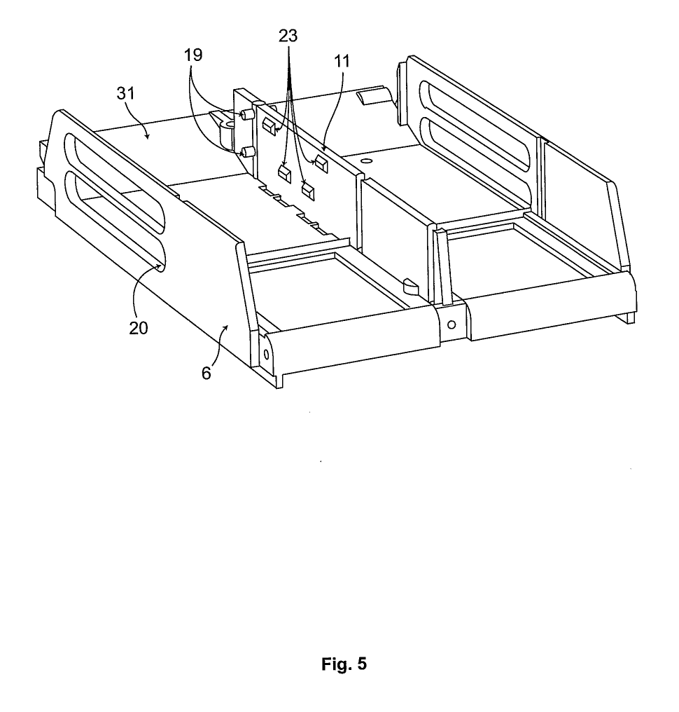

FIG. 5 is a perspective view of the assembly of FIG. 1 with all of the drive cards removed;

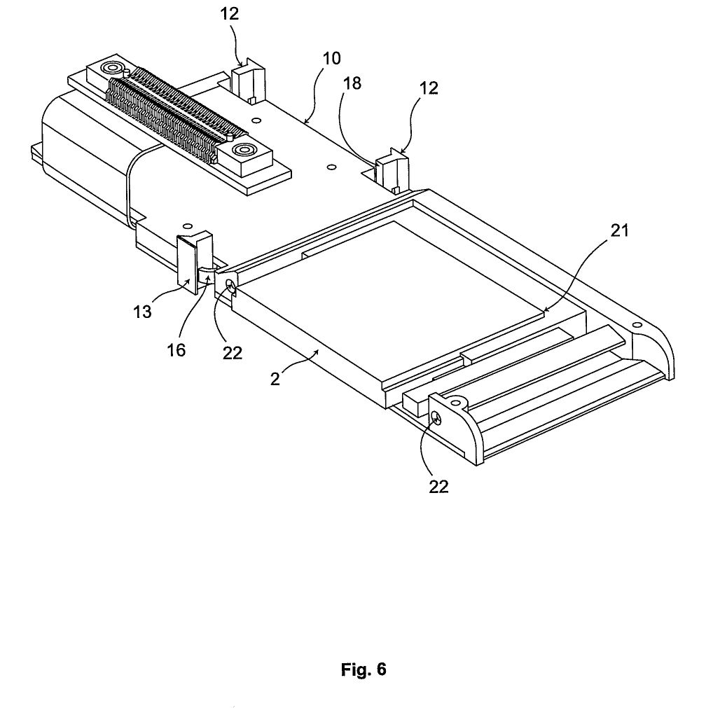

FIG. 6 is a perspective view of a drive card with a disk drive inserted therein;

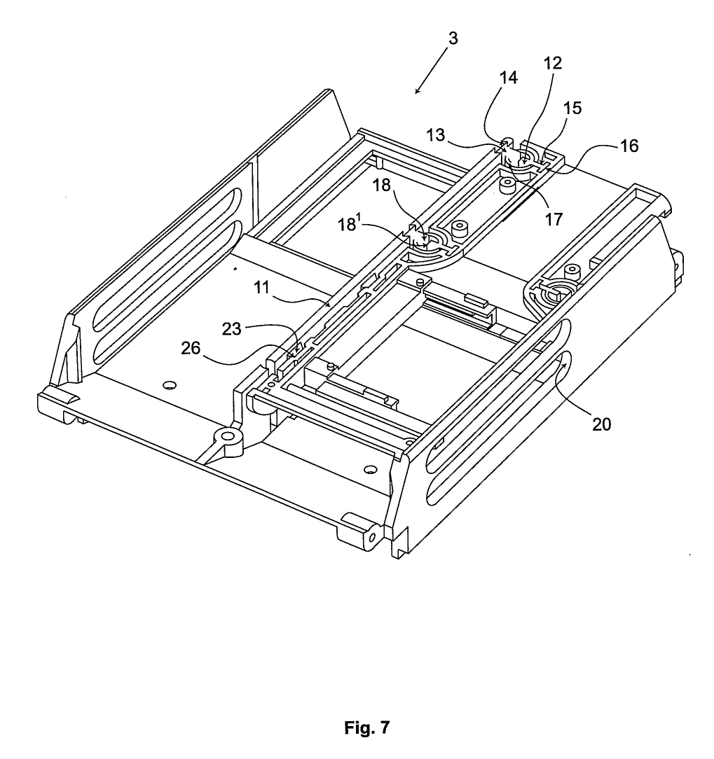

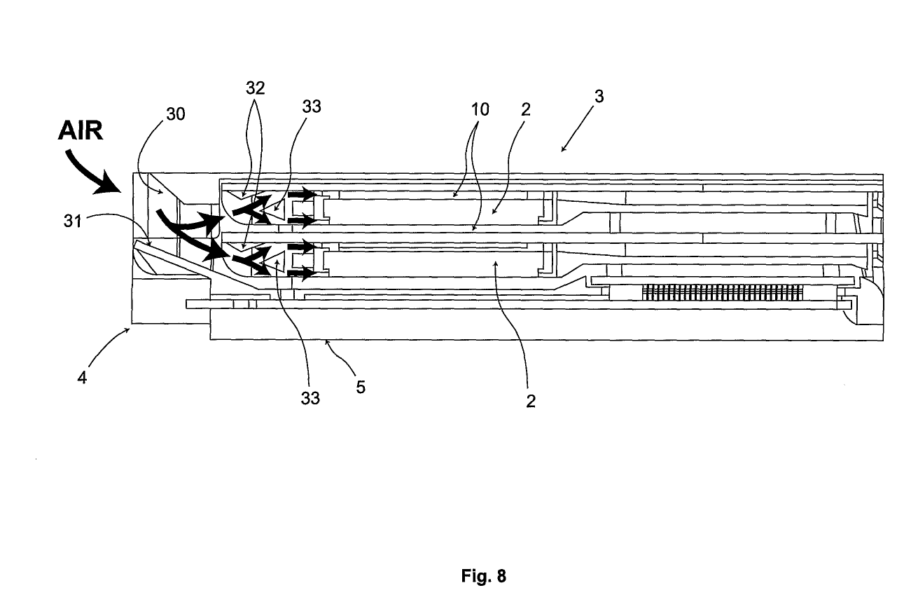

FIG. 7 is a perspective view from the other end of a partially assembled assembly of FIG. 1; and, FIG. 8 is a schematic partial longitudinal cross-sectional view of the assembly of FIG. 1.

Referring to the drawings, a disk drive carrier assembly 1 for carrying plural disk drives 2 has a casing 3 which has first and second opposed ends 4,5, opposed sides 6,7, and a top 8 and a bottom 9. In the specific example shown, the casing 3 is arranged so as to be able to carry four 1″ disk drives 2. The assembly 1 has a respective drive card 10 for each disk drive 2. The drive cards 10 are arranged in two adjacent columns each with two drive cards 10. A central dividing wall 11 is provided in the casing 3.

In the preferred embodiment, the drive cards 10 are floatingly supported in the casing 3. For this purpose, three isolators 12 are provided for each drive card 10. As seen most clearly in FIG. 3, each isolator 12 has a flared base 13 on one side which is received in a correspondingly shaped channel 14 provided in the respective side wall 6,7 and dividing wall 11. For ease of assembly, it is preferred that the isolators 12 can be slid up and down the channels 14. Opposite the flared base 13 is a T-shape base 15 (FIG. 7) which is received in a correspondingly shaped channel 16 in the drive card 10. Again, for ease of assembly, it is preferred that the isolators 12 can be slid up and down the channels 16 in the drive cards 10.

Each isolator 12 further has a pair of spring arms 17 which connect the flared base 13 and T-shape base 15 and bow outwards from the body of the isolator 12. The spring arms 17 are arranged so that in the rest position, the facing surfaces 18,18′ of the flared base 13 and T-shape base 15 are held away from each other. Thus, when assembled, sideways movement of the drive card 10 (which therefore includes rotation of the drive card 10 about a vertical axis) is controlled initially by virtue of the spring arms 17 of the isolators 12. The isolators 12 are preferably formed of a compliant material, such as an elastomer. The isolators 12 therefore provide for low rotational stiffness in the mounting of the drive card 10, which therefore allows the drive card 10 to move initially with low resistance by flexing of the spring arms 17. As will be appreciated, after a certain predetermined amount of movement of the drive card 10, the facing surfaces 18,18′ of the flared base 13 and T-shape base 15 abut each other, which considerably increases the stiffness of the mounting of the drive card 10 at this point. This floating mounting of the drive cards 10 effectively means that each drive card 10 is substantially isolated from all other drive cards 10 in the casing 3, and thus helps to reduce cross-talk between the drive cards 10 as the disk drives 2 are operated in use.

As will be seen, the isolators 12 for mounting each drive card 10 are positioned towards one end of the drive card 10, and are positioned away from the portion of the drive card 10 that receives the disk drive 2. The effect of this is that the centre of rotation of the drive card 10, which is largely determined by the position of the isolators 12 in this embodiment, is outside the footprint of the disk drive 2. This serves to reduce the positioning error that can occur owing to movement of the drive card 10 in use, this positioning error arising because the hard disk and the arm that carries the read/write head of the disk drive 2 reactively move in response to movement of the drive card 2. This aspect is discussed more fully in our co-pending PCT patent application no. PCT/GB2006/(agent's ref. P10345WO) which is filed concurrently herewith and the entire disclosure of which is hereby incorporated by reference. In the preferred embodiment shown herein, a fourth support 19 is provided towards the disk drive receiving portion of the respective drive cards 10. This fourth support 19 effectively sits under the drive card 10 to support the weight of the drive card 10 and disk drive 2 (when present) at that end, and does not materially contribute to the mechanics that determine the centre of rotation of the drive card 10.

In order to allow the disk drives 2 to be inserted into and removed from the drive cards 10, each side wall 6,7 of the casing 3 has through holes or slots 20 adjacent the disk drive receiving portion of the respective drive cards 10. Now, in practice, the disk drives 2 will typically be inserted into and removed from the drive cards 10 by a robotic arm (not shown). Because the drive cards 10 are floatingly mounted in the casing 3 by the isolators 12, it is desirable to be able to fix the location of the drive cards 10 in the casing 3 during the loading and unloading process. In the preferred embodiment, this is achieved by two sets of features.

First, as shown most clearly in FIG. 6, which shows a drive card 10 in which a disk drive 2 is received in the disk drive receiving portion 21 of the drive card 10, a detent 22 is provided on each side of the drive card 10 adjacent the disk drive receiving portion 21. The detents 22 in the assembled assembly 1 face the slots 20 in the respective side walls 6,7 and can be “seen” through the slots 20. Corresponding detents are provided on the robotic arm. In the example shown, the detents 22 in the drive card 10 are blind recesses and the corresponding detents on the robotic arm are pins. In use, as the robotic arm is offered up to the slot 20, the detents on the robotic arm engage the detents 22 in the drive card 10, thus locating the drive card 10 precisely with respect to the robotic arm.

The second set of features then enables the drive card 10 to be rigidly fixed within the casing 3 during the loading and unloading process. As shown most clearly in FIGS. 4 and 5, pairs of detents 23 are provided on the dividing wall 11 for each drive card 10. These dividing wall detents 23 are generally trapezoidal in cross-section and thus have chamfered top and bottom surfaces 24 and a flat face 25 that faces the drive card 10. Each drive card 10 has a correspondingly shaped detent in the form of a correspondingly shaped recess 26 (FIG. 7). In the rest position in which the drive card 10 is centred by the spring arms 17 of the isolators 12, the detents 23 on the dividing wall 11 are not engaged with the corresponding detents 26 on the drive card 10. On the other hand, when a disk drive 2 is being inserted, the robotic arm, which has already engaged the first detents 22 on the drive card 10, pushes the drive card 10 inwardly of the casing 3. This causes the detents 23 on the dividing wall 11 to engage fully with the corresponding detents 26 on the drive card 10, and thus provides for a (temporary) rigid mounting of the drive card 10 in the casing 3. Moreover, the position of the drive card 10 in the casing 3 is known in all three dimensions, which facilitates the automated insertion and unloading of the disk drive 2. This precise and rigid location of the drive card 10 is particularly important given that the insertion of the disk drive 2 has to make data and power connections between the disk drive 2 and the drive card 10.

During testing of a disk drive during manufacturing, the disk drive is typically stressed thermally over a wide temperature range. This is typically achieved by blowing hot or cold air as necessary over the disk drive. Typically, air is passed over the disk drive from one end, and is then returned under the disk drive to the first end, thus allowing the air to be recirculated, which allows energy efficiencies to be made and prevents the venting of air into the local environment. The preferred assembly 1 is constructed and arranged so as to provide for a substantially separate air flow over each disk drive 2 whilst still using the single original air source of the legacy test equipment.

Thus, and referring particularly to FIGS. 3 and 8, in use air enters from the first end 4 of the assembly 1. A first, vertically disposed baffle 30, which may effectively be an extension of the dividing wall 11 of the casing 3, vertically splits the incoming air stream to the left and right of the casing 3. Whilst the arrangement of the disk drive 2 in the casing 3 is generally symmetrical about the dividing wall 11, it may be that imbalances or inconsistencies in the arrangement of the apparatus causes disk drives 2 on one side of the dividing wall 11 to tend to heat up or cool down more rapidly and/or by a greater degree than the disk drives 2 on the other side. Accordingly, the position and shape of the vertically arranged baffle 30 may be arranged so as to provide different air flow rates to the two sides accordingly.

The bottom 5 of the casing 3 in this embodiment has a wedge surface 31 which drops downwardly into the body of the casing 3, which helps to straighten the air flow into the casing 3.

After passing over the wedge surface 31, the two air streams on either side of the dividing wall 11 are then each split in a horizontal plane by the lowermost drive card 10 on each side of the casing 3. The leading edge of each drive card 10 may have a wedge shape baffle surface 32, which again can be used to control the air flow entering the top and bottom halves of the casing 3 on each side.

At this point, there are now four separate air streams, one for each of the drive cards 10. These four air streams are then each split horizontally by a further wedge shape baffle 33 positioned just behind the leading edge of each drive card 10 so that air flows above and below each disk drive 2. (The final return air path is not shown in FIG. 8 for reasons of clarity.)

The position and shape of each of the baffles or air dividers can be set so as to provide the optimum air flow over each of the disk drives 2. Typically, this will take into account the velocity of the air flow that initially enters the casing 3, as well as the geometry of the various components of the assembly 1, and further taking into account any idiosyncrasies in the components that make up the assembly 1 and/or the disk drives 2 themselves.

Embodiments of the present invention have been described with particular reference to the examples illustrated. However, it will be appreciated that variations and modifications may be made to the examples described within the scope of the present invention.

1. A disk drive carrier assembly for carrying plural disk drives, the assembly comprising:
a casing having first and second opposed ends, opposed sides, a top and a bottom;
a plurality of drive cards in the casing, each drive card having a disk drive receiving portion for receiving a disk drive and providing at least one of a power and a data connection to a said disk drive; and,
a baffle arrangement for splitting an air stream entering the casing at a first end of the casing to flow over the disk drive receiving portion of each of the drive cards;
the drive cards and the baffle arrangement being arranged so that air flows only in parallel over the disk drive receiving portion of each of the drive cards whereby each disk drive receiving portion receives air that has not passed over another disk drive receiving portion of the assembly.

2. An assembly according to claim 1, wherein at least some of the drive cards are arranged adjacent each other at the same height between the top and bottom of the casing, the baffle arrangement comprising at least one baffle arranged between the top and bottom of the casing for splitting a said air stream towards the sides of the casing thereby to provide a separate air flow for each of said adjacent drive cards.

3. An assembly according to claim 1, wherein at least some of the drive cards are arranged adjacent each other at the same lateral position between the sides of the casing, the baffle arrangement comprising at least one baffle arranged between the sides of the casing for splitting a said air stream towards the top and bottom of the casing thereby to provide a separate air flow for each of said adjacent drive cards.

4. An assembly according to claim 1, wherein at least a first set of the drive cards are arranged adjacent each other at the same height between the top and bottom of the casing, the baffle arrangement comprising at least a first baffle arranged between the top and bottom of the casing for splitting a said air stream towards the sides of the casing thereby to provide a separate air flow for each of said adjacent drive cards of the first set, and wherein at least a second set of the drive cards are arranged adjacent each other at the same lateral position between the sides of the casing, the baffle arrangement comprising at least a second baffle arranged between the sides of the casing for splitting a said air stream towards the top and bottom of the casing thereby to provide a separate air flow for each of said adjacent drive cards of the second set.

5. An assembly according to claim 1, comprising a return air flow path to return air that has passed over the disk drive cards to the first end of the casing.

6. An assembly according to claim 1, comprising a plurality of slots in one or both side walls of the casing to enable disk drives to be inserted into and removed from the respective disk drive cards through the side walls of the casing.

7. A disk drive carrier assembly for carrying plural disk drives, the assembly comprising:
a casing having first and second opposed ends, opposed sides, a top and a bottom; and,
a plurality of drive cards in the casing, each drive card having a disk drive receiving portion for receiving a disk drive and providing at least one of a power and a data connection to a said disk drive;
at least one of the drive cards being floatingly mounted in the casing by at least one isolator; and,
said at least one drive card having at least a first detent that is constructed and arranged to engage with a corresponding detent in the casing as a disk drive is inserted into said at least one drive card, thereby locating said at least one drive card in the casing during insertion of a disk drive.

8. An assembly according to claim 7, wherein said at least one drive card has a second detent that can receive a corresponding detent on a robotic arm that is used to insert a disk drive into said at least one drive card, thereby locating said at least one drive card relative to a said robotic arm.

9. An assembly according to claim 7, comprising a plurality of slots in one or both side walls of the casing to enable disk drives to be inserted into and removed from the respective disk drive cards through the side walls of the casing.

10. A method of loading a disk drive into a disk drive carrier assembly that can carry plural disk drives, the assembly having a casing having first and second opposed ends, opposed sides, a top and a bottom; and, a plurality of drive cards in the casing, each drive card having a disk drive receiving portion for receiving a disk drive and providing at least one of a power and a data connection to a said disk drive; at least one of the drive cards being floatingly mounted in the casing by at least one isolator; the method comprising:
engaging at least a first detent on said at least one drive card with a corresponding detent in the casing as a disk drive is inserted into said at least one drive card, thereby locating said at least one drive card in the casing during insertion of the disk drive.

11. A method according to claim 10, comprising, prior to said first engaging step, engaging a detent on a robotic arm with a second detent on said at least one drive card to locate said at least one drive card relative to the robotic arm, and then carrying out the first engaging step by pushing the robotic arm in towards the interior of the casing.

12. A method according to claim 10, wherein said disk drive is inserted into and removed from the disk drive card through a slot in the side wall of the casing.

13. A method according to claim 11, wherein said disk drive is inserted into and removed from the disk drive card through a slot in the side wall of the casing.

14. An assembly according to claim 8, comprising a plurality of slots in one or both side walls of the casing to enable disk drives to be inserted into and removed from the respective disk drive cards through the side walls of the casing.

15. An assembly according to claim 2, comprising a return air flow path to return air that has passed over the disk drive cards to the first end of the casing.

16. An assembly according to claim 3, comprising a return air flow path to return air that has passed over the disk drive cards to the first end of the casing.

17. An assembly according to claim 4, comprising a return air flow path to return air that has passed over the disk drive cards to the first end of the casing.

18. An assembly according to claim 2, comprising a plurality of slots in one or both side walls of the casing to enable disk drives to be inserted into and removed from the respective disk drive cards through the side walls of the casing.

19. An assembly according to claim 3, comprising a plurality of slots in one or both side walls of the casing to enable disk drives to be inserted into and removed from the respective disk drive cards through the side walls of the casing.

20. An assembly according to claim 4, comprising a plurality of slots in one or both side walls of the casing to enable disk drives to be inserted into and removed from the respective disk drive cards through the side walls of the casing.
